(19) United States
(12) Patent Application Publication
(10) Pub. No.: US 2005/0259416 A1
(43) Pub. Date: Nov. 24, 2005

(54) Dual lighting system

(76) Inventors: Kevin W. Gauna, Berkeley, CA (US); Erik R. Page, Winters, CA (US); Michael Siminovitch, Woodland, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 11/157,696

(22) Filed: Jun. 20, 2005

Related U.S. Application Data
(63) Continuation-in-part of application No. 10/616,313, filed on Jul. 8, 2003, now Pat. No. 6,909,239.
(60) Provisional application No. 60/607,124, filed on Sep. 3, 2004.
(60) Provisional application No. 60/635,348, filed on Dec. 9, 2004.

(51) Int. Cl. F21V 9/00

(52) U.S. Cl. 362/227

(57) ABSTRACT

A dual lighting system including an LED illuminator, a lamp positioned in proximity to the LED illuminator. It also includes a motion sensor for detecting motion around the lighting system, a manual switch, and a control system which is coupled to the manual switch, the motion sensor, the lamp, and the LED illuminator. When the manual switch is activated, the control system is configured to turn on the lamp. If the motion sensor no longer detects motion around the dual lighting system, the control system is configured to turn off the lamp.

### RELATED APPLICATION

This application is a continuation-in-part of a pending U.S. patent application, entitled “Dual LED/Incandescent Security Fixture,” by inventor Kevin W. Gauna, having Ser. No. 10/616,313 and a filing date of 8 Jul. 2003. This application hereby claims priority under 35 U.S.C. §120 to the above-listed patent application. Moreover, the above-listed application is hereby incorporated by reference.

### BACKGROUND

1. Field of the Invention

The invention relates generally to LED lighting systems and more particularly to indoor dual lighting systems with LEDs.

2. Related Art

As LED technology progresses, LEDs will be used for many lighting applications. However, the cost of light emitted from LEDs (in dollars per lumen) remains above that of other typical light sources. This cost will drop as the technology matures and more illumination opportunities will be commercially viable. For example, exit signs and traffic signals are examples of colored lighting markets that have seen widespread commercial success by LEDs and soon may be dominated if not monopolized by LEDs.

A low-cost and low-power lighting system is a lighting application of great interest. Currently, LEDs are not the ideal choice for lighting applications because of the high costs associated with high output LED systems. Incandescent lights are inexpensive and can be used for lighting applications, but they consume much more energy. Thus, what is needed is a lighting system without the above-described problems.

### SUMMARY

One embodiment of the present invention provides a dual lighting system including an LED illuminator, a lamp positioned in proximity to the LED illuminator. It also includes a motion sensor for detecting motion around the lighting system, a manual switch, and a control system which is coupled to the manual switch, the motion sensor, the lamp, and the LED illuminator. When the manual switch is activated, the control system is configured to turn on the lamp. If the motion sensor no longer detects motion around the dual lighting system, the control system is configured to turn off the lamp.

In a variation on this embodiment, the LED illuminator is always on.

In a variation on this embodiment, if the motion sensor no longer detects motion around the lighting system for a pre-specified amount of time, the control system turns off the lamp.

In a further variation on this embodiment, when the control system turns off the lamp, the control system also turns on the LED illuminator.

In a variation on this embodiment, the manual switch is a momentary-off switch.

In a variation on this embodiment, when the lamp is on, activating the manual switch causes the control system to turn off the lamp, and to turn on the LED illuminator.

In a variation on this embodiment, the dual lighting system includes a battery backup module for the LED illuminator, which provides power to the LED illuminator if there is a power outage.

In a further variation on this embodiment, the battery backup module uses rechargeable batteries which recharge when power is supplied to the dual lighting system.

In a variation on this embodiment, the LED illuminator is oriented to provide indirect light by pointing toward the ceiling or toward a wall.

In a variation on this embodiment, the lamp is an incandescent lamp, a halogen lamp, a fluorescent lamp, or a second LED illuminator.

In a variation on this embodiment, the dual lighting system is part of an indoor lighting fixture.

In a variation on this embodiment, the dual lighting system is part of an outdoor lighting fixture.

In a variation on this embodiment, the dual lighting system includes a light sensor which senses a lighting level. If the room in which the dual lighting system is located is dark and if the motion sensor detects motion around the dual lighting system, the control system is configured to turn on the lamp.

In a further variation on this embodiment, the control system compares the current lighting level reported by the light sensor and adjusts the brightness of the lamp to reach a pre-specified lighting level.

### BRIEF DESCRIPTION OF THE FIGURES

FIG. 1 presents a dual LED/incandescent security lighting system in accordance with an embodiment of the present invention.

FIGS. 2-5 present variations of the dual LED/incandescent security lighting system of FIG. 1 in accordance with embodiments of the present invention.

FIG. 6 presents the dual LED/incandescent security lighting system with a separate LED drop unit in accordance with an embodiment of the present invention.

FIG. 7 presents a block diagram of a control system for the dual LED/incandescent outdoor lighting system in accordance with an embodiment of the present invention.

FIG. 8 presents a block diagram of a control system for the dual LED/incandescent indoor lighting system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

LED/Incandescent Security Lighting System

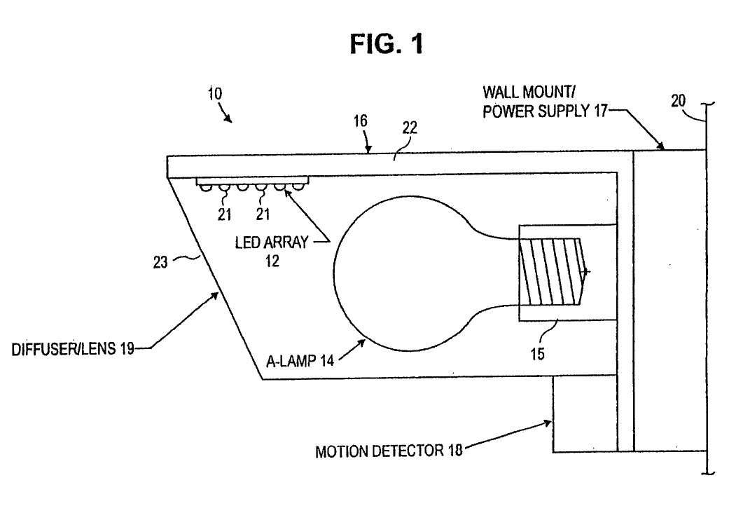

As shown in FIG. 1, hybrid LED/incandescent light fixture 10 combines an LED array 12 and an incandescent lamp (A-lamp) 14 in a single housing 16. The incandescent source or lamp 14 screws into a standard socket 15 and is held in a horizontal position. The LED array 12 is placed facing down from the top 22 of the housing 16, near the front edge, and extending forward substantially beyond A-lamp 14. The top 22 of housing 16 not only supports the LED array 12 but also provides a heatsink for the LED array 12 and provides a physical shield to prevent light from either the LED array 12 or A-lamp 14 from traveling upwards into the night sky. Housing 16 is attached to a wall mount/power supply unit 17, which is attached to wall 20 and electrically connected to a power source, typically standard electrical wiring from a power line. Socket 15 and LED array 12 are electrically connected to unit 17 for power. A motion detector 18 is mounted below housing 16 (or elsewhere) and is also electrically connected to unit 17 for power. The control system for fixture 10 is contained in unit 17.

Also forming a part of housing 16, extending down from top 22 and surrounding or enclosing LED array 12 and A-lamp 14, is a diffuser or lens 19, which typically is a diffuser but also may be a clear lens. The front part 23 of diffuser/lens 19 is typically tapered inwardly from top to bottom. LED array 12 includes a plurality of LEDs 21. The LEDs are typically amber or yellow in color, but may be other colors or even white. A-lamp 14 may be replaced by a halogen lamp, or compact fluorescent lamp, or other lamp. Diffuser/lens 19 allows the light from LED array 12 and from A-lamp 14 to pass to the local environment, generally illuminating the area around fixture 10. Diffuser/lens 19 is typically formed of flat or roughened panes of clear or translucent glass or plastic.

In operation, a sensor detects the occurrence of darkness and turns on the LED array 12. After that, whenever motion sensor 18 detects motion in the vicinity of fixture 10, the A-lamp 14 is switched on, and remains on for a preset time. LED array 12 may remain on when A-lamp 14 is on, or it may shut off to conserve energy and to prevent color shadows.

The construction of the fixture 10 is such that the light output is directed down, mitigating light pollution issues. This fixture is intended as a replacement fixture: it either replaces a porch light in a retrofit application, or is used in new construction as an alternative to another porch light.

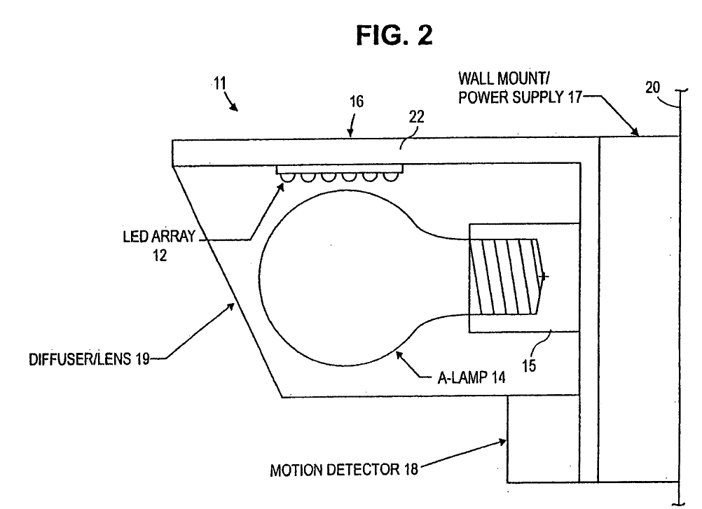

FIG. 2 shows a dual LED/incandescent fixture which is very similar to fixture 10 of FIG. 1 except for the position of LED array 12 relative to A-lamp 14. In fixture 11, LED array 12 is recessed into housing 16 so that it is over A-lamp 14. Most of the light from LED array 12, then passes through A-lamp 14, which acts as a diffuser, so lens 19 is then typically clear. The remaining components are the same as in FIG. 1.

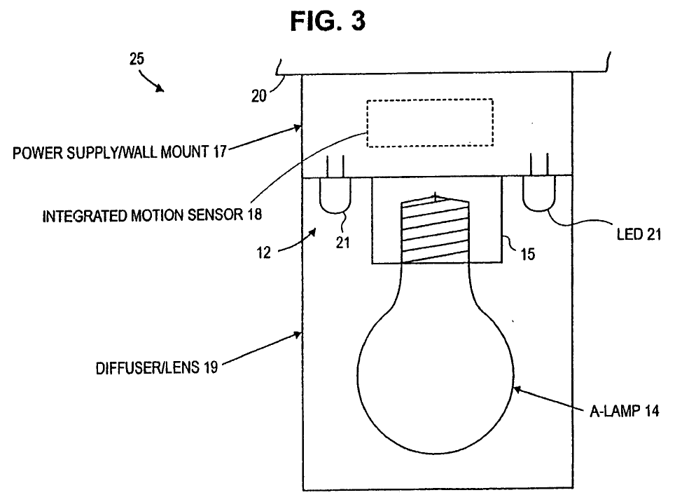

FIG. 3 shows an alternate embodiment of the invention with the incandescent lamp 14 in a lamp down orientation. The LEDs 21 are mounted in a ring around the base of the A-lamp 14. Dual LED/incandescent fixture 25 incorporates many of the same components as fixtures 10, 11 but in a different arrangement. Fixture 25 hangs down from a wall or overhang 20. Power supply/wall mount unit 17 is attached under wall 20 and contains the electrical connections to the power source and the control system. Socket 15, into which A-lamp 14 screws, is mounted under and electrically connected to unit 17. LEDs 21 are mounted on and electrically connected to unit 17, forming an array 12. Motion sensor 18 is integrated into unit 17. Diffuser/lens 19 extends down from unit 17 and encloses and surrounds LEDs 21 and A-lamp 14.

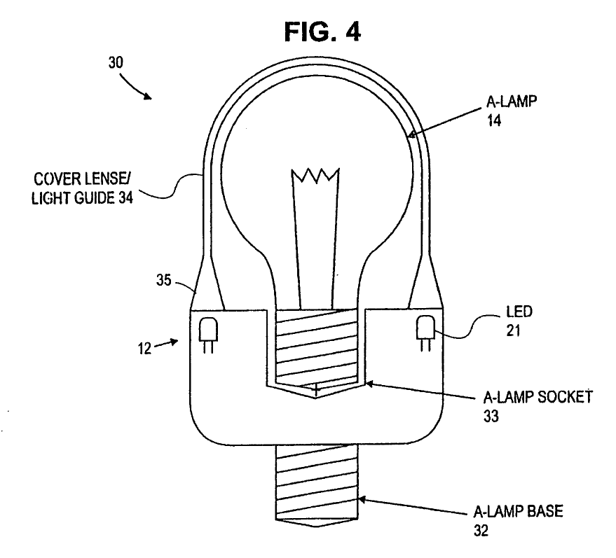

FIG. 4 shows another embodiment of the invention that is intended as a screw-in retrofit. In the dual fixture 30, the LEDs 21 and associated electronics are integrated into a screw-in A-lamp type base 32. This base 32 then receives a standard A-lamp, 14 in A-lamp socket 33. Base 32 screws into a standard socket in a wall which is connected to electrical power, e.g. in a standard porch light fixture. A-lamp 14 and LEDs 21 are thereby electrically connected to a power source. A light guide or cover lens 34 that attaches to the base 32 may be necessary to control the light distribution, as well as mitigate direct glare from the LEDs 21. LEDs 21 are arranged in an array 12 around the edge of base 32 and are aligned with an input section 35 of light guide/lens 34.

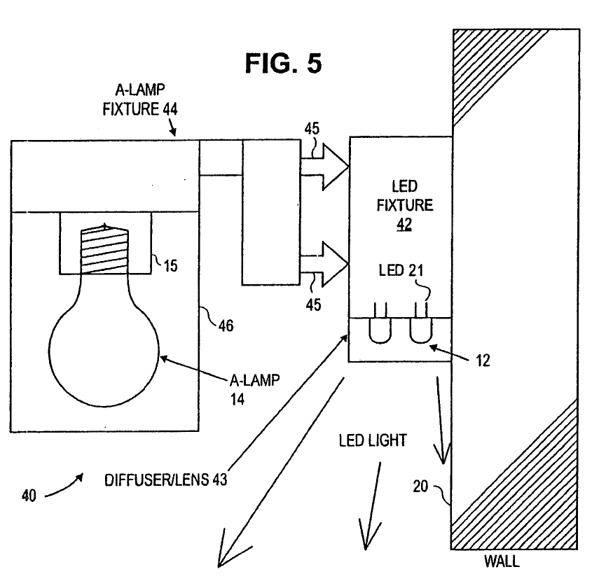

In an alternate embodiment shown in FIG. 5, dual LED/incandescent system 40 separates the LED lighting component from the incandescent lighting fixture. There are separate side-by-side fixtures, LED fixture 42 and A-lamp fixture 44. A-lamp fixture 44 is essentially a standard porch light fixture. LED fixture 42 attaches to wall 20, e.g. at an outdoor junction box. An array 12 of LEDs 21 is mounted in LED fixture 42, facing downward, and enclosed or surrounded by a diffuser/lens 43. LED fixture 42 is built to receive an A-lamp fixture 44 on its front surface, as shown by arrows 45. A-lamp fixture 44 includes a downward facing incandescent lamp 14, which screws into electrical socket 15. A diffuser/lens 46 encloses and surrounds A-lamp 14. The electronics, including the motion sensor, are typically mounted in LED fixture 42.

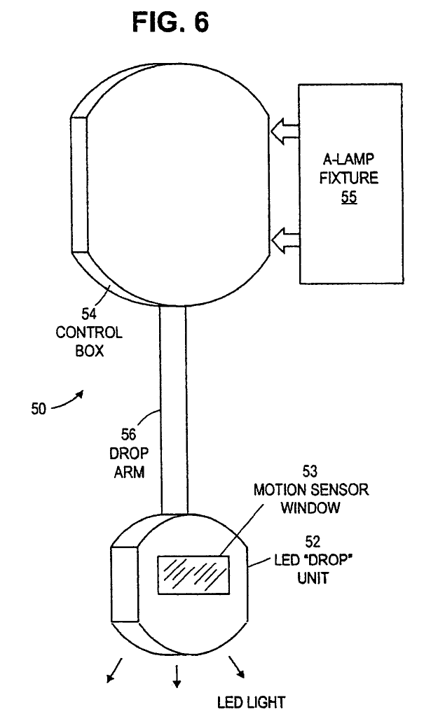

Another embodiment of the invention, shown in FIG. 6, also separates the LED light component from the incandescent fixture. But instead of having the LED, motion sensor, and control electronics in the same box, dual LED/incandescent system 50 has an LED “drop” unit 52 under the main incandescent unit control box 54. Control box 54 is configured to mount onto a wall. The front surface is configured to receive a standard “porch light” type fixture 55 (similar to fixture 44 in FIG. 5). Control box 54 typically contains the LED driver circuit, the motion control circuit, and the daylight sensing circuit. Drop unit 52 contains the LEDs and the motion-sensor, which operates through motion sensor window 53. Drop unit 52 is connected to main unit 54 by drop arm 56. The drop arm could have an adjustable length, and could be set by the end user according to the particular installation environment. This “drop” feature accomplishes several things. It lowers the LED emitters, reducing the problem of direct glare from the LEDs and increasing the illuminance on the ground below the fixture. It allows the motion sensor unit, also incorporated into the drop unit, to clear the porch light fixture and see the appropriate field of view for proper motion sensing operation. It also separates the heat generating LEDs from the rest of the unit, keeping this heat away from the control electronics.

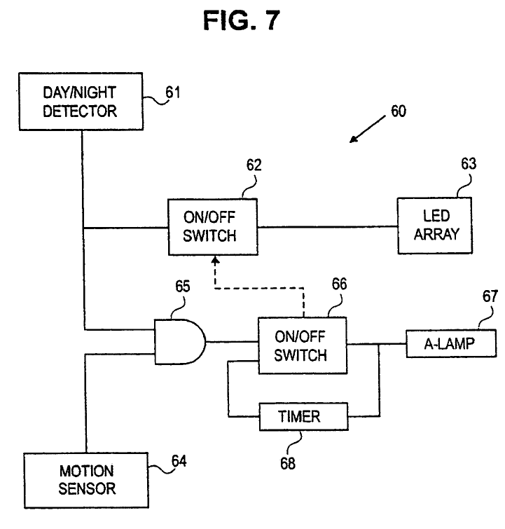

FIG. 7 presents a block diagram of control system 60 for the dual LED/incandescent outdoor lighting system in accordance with an embodiment of the present invention. A detector 61 detects the onset of darkness and actuates a switch 62 which turns on LED array 63. During darkness, when motion sensor 64 detects motion, its output signal is combined with the output signal from detector 61, e.g. in AND gate 65, to actuate a second switch 66 to turn on A-lamp 67. Once A-lamp 67 is turned on, a timer 68 which is also actuated by switch 66 may be used to turn off A-lamp 67 after a preset and selectable period of time. Switch 66, when turned on, may also turn off switch 62 to shut off the LED array 63 when A-lamp 67 is on.

This type of hybrid approach to LED illumination has the following advantages and benefits.

1) The LED source (one or more LEDs in an array) consumes a relatively small amount of power compared to the incandescent source, yielding substantial energy savings without a loss in functionality.

2) The LED source provides ambient illumination to the area, eliminating the “all-or-nothing” effect of traditional motion sensor fixtures.

3) The LED source will have a very long lifetime, ensuring at least some illumination to the control area when the incandescent lamp fails.

4) With colored LED sources, the motion activated incandescent lamp will provide a color change when triggered, increasing the conspicuousness of the motion activation and increasing the security benefit of the trigger.

5) With colored LED sources, different nighttime aesthetics can be achieved.

6) The combination of the LED source(s) and the incandescent source yields the best dollars per lumen ratio for the target applications. The number of (expensive) LEDs is kept to a minimum while, at the same time, the incandescent lamp provides a high lumen output for good visibility when the application area is occupied.

LED/Incandescent Indoor Lighting System

The day/night detector makes the LED/incandescent security lighting system well suited for outdoor use. The incandescent light turns on only when it is dark and when there is someone passing by the area covered by the motion sensor. However, for indoor applications such as hotel rooms, there is little or no sunlight, so therefore the day/night detector can be removed. One embodiment of the present invention provides an indoor lighting system which is turned on manually but shuts off automatically.

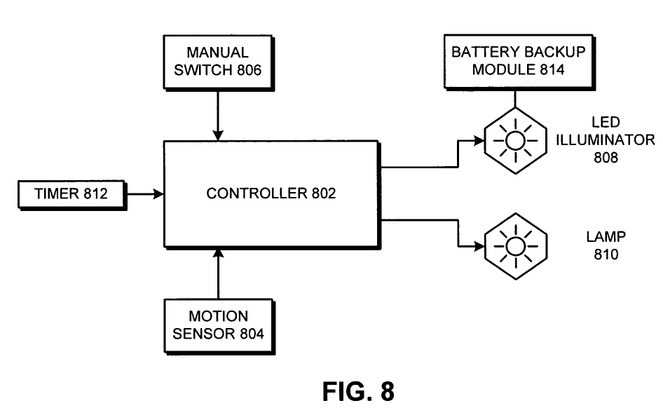

FIG. 8 presents a block diagram of a control system for the dual LED/incandescent indoor lighting system in accordance with an embodiment of the present invention. It contains controller 802, motion sensor 804, manual switch 806, LED illuminator 808, lamp 810, timer 812, and battery backup module 814. Note that lamp 810 can be an incandescent lamp, a halogen lamp, a fluorescent lamp, or any other light source.

In one embodiment of the present invention, when manual switch 806 is activated, controller 802 turns on lamp 810. In one embodiment of the present invention, LED illuminator 808 is always on, thus providing a night-light. In another embodiment of the present invention, LED illuminator 808 is turned off when controller 802 turns on lamp 810.

If lamp 810 is on and if motion sensor 804 no longer detects motion around the lighting system, controller 802 turns off lamp 810. In another embodiment of the present invention, controller 802 turns off lamp 810 if motion sensor 804 does not detect motion around the lighting system for a pre-specified amount of time. Controller 802 determines whether the pre-specified amount of time has passed by checking the elapsed time reported by timer 812. In yet another embodiment of the present invention, controller 802 turns off LED illuminator 808 when turning off lamp 810.

Note that if lamp 810 is off and motion sensor 804 detects motion around the lighting system, controller 802 does not turn on lamp 810. Instead, controller 802 waits for manual switch 806 to activate before turning on lamp 810.

In one embodiment of the present invention, if lamp 810 is on, activating manual switch 806 causes controller 802 to turn off lamp 810. Note that if LED illuminator 808 is currently off, controller 802 turns on LED illuminator 808 when it turns off lamp 810, thereby providing a low-power lighting source.

In one embodiment of the present invention, battery backup module 814 provides power to LED illuminator 808 if there is a power failure. Note that battery backup module can contain rechargeable batteries which recharge when power is supplied to the LED/incandescent indoor lighting system.

In one embodiment of the present invention, manual switch 806 is a momentary switch which, when depressed, causes an open circuit momentarily. Note that power is always going to the lighting system. If lamp 810 is initially on (State A), depressing the momentary switch causes controller 802 to turn off lamp 810 and turn on LED illuminator 808 (State B). State B is a night-light state.

If there is a power outage, then battery backup module provides power to LED illuminator 808 to provide light to the room (State C).

In one embodiment of the present invention, the LED illuminator is oriented toward the ceiling or toward a wall to provide indirect light.

In one embodiment of the present invention, a light sensor is used to sense lighting level. If it is dark and motion sensor 804 detects motion around the dual lighting system, controller 802 turns on lamp 810.

In another embodiment of the present invention, controller 802 adjusts the brightness of lamp 810 to a pre-specified lighting level based on the current lighting level of the room. For instance, if some sunlight reaches the room, but the lighting level does not reach the pre-specified lighting level, controller 802 adjusts the brightness of lamp 810 to provide enough light to reach the pre-specified lighting level.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A dual lighting system, comprising:
an LED illuminator;
a lamp positioned in proximity to the LED illuminator;
a motion sensor for detecting motion around the lighting system;
a manual switch; and
a control system coupled to the manual switch, the motion sensor, the lamp, and the LED illuminator;
wherein when the manual switch is activated, the control system is configured to turn on the lamp; and
wherein if the motion sensor no longer detects motion around the dual lighting system, the control system is configured to turn off the lamp.

2. The dual lighting system of claim 1, wherein the LED illuminator is always on.

3. The dual lighting system of claim 1, wherein if the motion sensor no longer detects motion around the lighting system for a pre-specified amount of time, the control system turns off the lamp.

4. The dual lighting system of claim 3, wherein when the control system turns off the lamp, the control system also turns on the LED illuminator.

5. The dual lighting system of claim 1, wherein the manual switch is a momentary-off switch.

6. The dual lighting system of claim 1, wherein when the lamp is on, activating the manual switch causes the control system to turn off the lamp, and to turn on the LED illuminator.

7. The dual lighting system of claim 1, further comprising a battery-backup module for the LED illuminator, wherein the battery backup module provides power to the LED illuminator if there is a power outage.

8. The dual lighting system of claim 7, wherein the battery backup module uses rechargeable batteries which recharge when power is supplied to the dual lighting system.

9. The dual lighting system of claim 1, wherein the LED illuminator is oriented to provide indirect light by pointing toward the ceiling or toward a wall.

10. The dual lighting system of claim 1, wherein the lamp is:
an incandescent lamp;
a halogen lamp;
a fluorescent lamp; or
a second LED illuminator.

11. The dual lighting system of claim 1, wherein the dual lighting system is part of an indoor lighting fixture.

12. The dual lighting system of claim 1, wherein the dual lighting system is part of an outdoor lighting fixture.

13. The dual lighting system of claim 1, further comprising:
a light sensor which senses lighting level;
wherein if the room in which the dual lighting system is located is dark and if the motion sensor detects motion around the dual lighting system, the control system is configured to turn on the lamp.

14. The dual lighting system of claim 13, wherein the control system receives a lighting level reported by the light sensor and adjusts the brightness of the lamp to reach a pre-specified lighting level.

15. The dual lighting system of claim 1,
wherein if the motion sensor detects motion around the dual lighting system, the control system is configured to turn on the lamp; and
wherein if the motion sensor no longer detects motion around the dual lighting system, the control system is configured to turn off the lamp, thereby providing an automatic-on and an automatic-off dual lighting system.

16. The dual lighting system of claim 15, wherein if the motion sensor no longer detects motion around the lighting system for a pre-specified amount of time, the control system turns off the lamp.
